(19) United States
(12) Patent Application Publication
(10) Pub. No.: US 2008/0296847 A1
(43) Pub. Date: Dec. 4, 2008

(54) Packing ring with dovetail feature

(75) Inventors: Richard Chevrette, Troy, NY (US); Jeyaruban Amirtharajah, Niskayuna, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/807,754

(22) Filed: May 30, 2007

(51) Int. Cl. F16J 15/40

(52) U.S. Cl. 277/422

(57) ABSTRACT

A packing ring in a multi-staged turbine that includes two ring segments joined by a dovetail feature. In some embodiments, the dovetail feature may include a male/female configuration. In other embodiments, the dovetail feature may include an insert/groove configuration. The insert of the insert/groove configuration may include a protrusion that extends from an approximately flat surface of an end of one of the ring segments. The groove of the insert/groove configuration may include a notch in an approximate flat surface of an end of one of the ring segments. The insert of the insert/groove configuration and the groove of the insert/groove configuration may be of a similar size such that the insert closely fits within the groove.

### TECHNICAL FIELD

This present application relates generally to multi-stage turbine engines. More specifically, but not by way of limitation, the present application relates to the packing rings installed between the respective stages to minimize fluid leakage from one stage to the next.

### BACKGROUND OF THE INVENTION

In turbines the efficiency of the turbine is, in part, affected by the ability to prevent the working fluid from leaking from one stage to the next. For this purpose, one or more packing rings may be installed at the interface between stages, and between the outermost stages of the turbine and the atmosphere. The rings provide both a longitudinal seal between stages so the working fluid is properly confined within a stage. The packing ring (or rings) forming the seal comprises a plurality of ring segments (typically 4-12). These are curved or arcuate in shape, and assembled in an end-to-end abutment with one another to form the ring. Each ring segment includes sets of teeth that extend across an inner face of the segment. These teeth interface with the shaft to form a path or labyrinth sufficiently convoluted that leakage from one stage to the next, or to the atmosphere, is minimized. An effective seal is thereby created.

It will be understood by those skilled in the art that packing rings function in an elevated temperature environment and therefore the ring segments experience thermal expansion and contraction. These effects must be taken into account when the packing ring is assembled so a butt gap, which is created between adjacent ring segments, is sufficiently large to accommodate changes caused by the thermal characteristics. However, if the gap is too large, then a residual space will remain between segments after they thermally expand, and a leakage path will be created. On the other hand, if the gap is too small, then when the segments expand, they will butt together and expand to a larger diameter thus increasing the radial clearance between the packing ring and the turbine rotor shaft. Again, an increased leakage path will be created.

Predicting the appropriate butt gap, therefore, becomes essential. However, the varying environment of the turbine as well as other inaccuracies associated with predicting thermal expansion and contraction of packing rings generally means that butt gap allowances are rarely accurate. This condition leads to increased leakage between stages. Further, remedial measures to correct butt gap inaccuracies lead to greater downtime for the turbine. It will be appreciated that there is a need for an improved ring segment design that alleviates this condition.

### BRIEF DESCRIPTION OF THE INVENTION

The present application thus describes a packing ring in a multi-staged turbine that includes two ring segments joined by a dovetail feature. In some embodiments, the dovetail feature may include a male/female configuration. In other embodiments, the dovetail feature may include an insert/groove configuration. The insert of the insert/groove configuration may include a protrusion that extends from an approximately flat surface of an end of one of the ring segments. The groove of the insert/groove configuration may include a notch in an approximate flat surface of an end of one of the ring segments. The insert of the insert/groove configuration and the groove of the insert/groove configuration may be of a similar size such that the insert closely fits within the groove.

In some embodiments, the insert of the insert/groove configuration may include a rectangular protrusion that is positioned at the end of ring segment. The length of the insert may traverse the radial thickness of the ring segment.

In some embodiments, the groove of the insert/groove configuration may include a rectangular depression that is positioned in the end of ring segment. The length of the groove traverses the radial thickness of the ring segment.

The present application may further describe a packing ring in a multi-staged turbine that includes a ring segment that includes an insert at one end and a ring segment that includes a groove at one end. The insert and the groove may be sized so that the insert may engage the groove.

The outer radial face of each of the ring segments may include an engagement feature so that the ring segments may be engaged by an inner radial face of a turbine casing, and the inner radial face of each of the ring segments may include teeth.

The insert may include a protrusion that extends from an approximately flat surface of an end of one of the ring segments. The groove may include a notch in an approximate flat surface of an end of one of the ring segments. The insert and the groove may be of a similar size such that the insert closely fits within the groove.

In some embodiments, the insert of the insert/groove configuration may include a rectangular protrusion that is positioned at the end of ring segment. The length of the insert may traverse the radial thickness of the ring segment. In some embodiments, the groove may include a rectangular depression that is positioned in the end of ring segment. The length of the groove may traverse the radial thickness of the ring segment.

These and other features of the present application will become apparent upon review of the following detailed description of the preferred embodiments when taken in conjunction with the drawings and the appended claims.

### BRIEF DESCRIPTION OF THE DRAWINGS

FIG. 1 is a perspective view of two conventional ring segments.

FIG. 2 is a perspective view of two ring segments according to an exemplary embodiment of the present invention.

FIG. 3 is a perspective view of a ring segment according to an exemplary embodiment of the present invention.

FIG. 4 is a perspective view of a ring segment according to an exemplary embodiment of the present invention.

FIG. 5 is a perspective view of a ring segment butt gap according to an exemplary embodiment of the present invention.

### DETAILED DESCRIPTION OF THE INVENTION

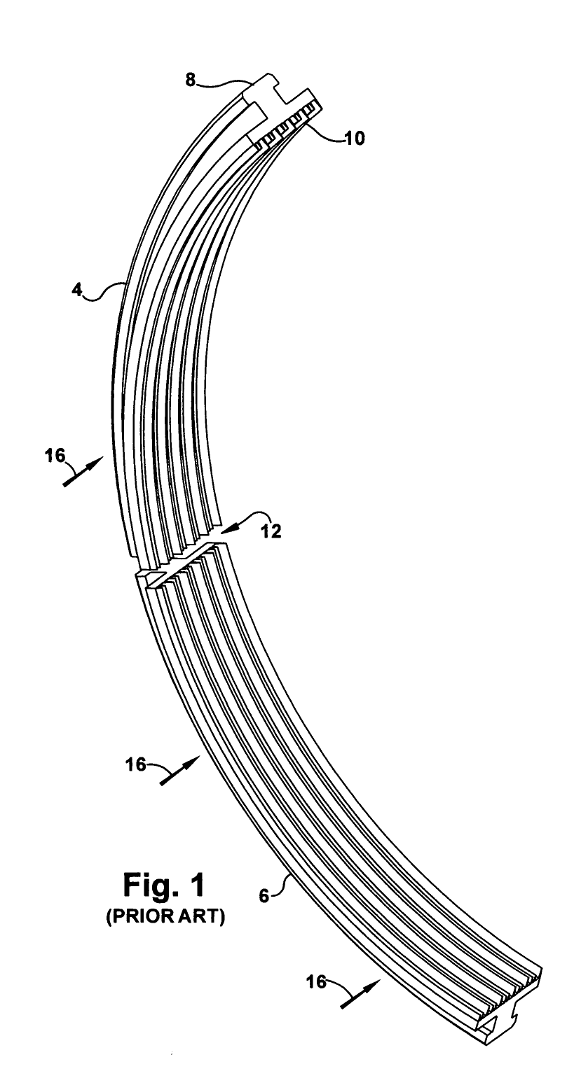

Referring now to the figures, where the various numbers represent like parts throughout the several views, FIG. 1 demonstrates two conventional ring segments 4, 6 that may be used to form packing rings in a multi-staged turbine. It will be understood that other ring segments may be used with the ring segments 4, 6 so to complete a packing ring of 180°. The complete packing ring may provide a longitudinal seal between turbine stages so the working fluid is properly confined within a stage. As shown, the outer radial face of the ring segments 4, 6 may have an engagement feature 8 so that the ring segments may be engaged by an inner radial face of a turbine casing. In this manner, the ring segments may be joined end to end to enclose a stage within a gas or steam turbine.

It will be understood that the ring segments 4, 6 may include several teeth 10 that extend across an inner radial face of the ring segment 4, 6. These teeth 10 may interface with the shaft (not shown) to form a path or labyrinth sufficiently convoluted that leakage from one stage to the next, or to the atmosphere, is minimized. Typically, the ring segments 4, 6 may be made from bronze, steel or other similar materials.

As shown, between the ring segment 4 and the ring segment 6 a butt gap 12 may be maintained. The butt gap 12 is a gap between ring segments that allows for the thermal expansion when the ring segments 4, 6 are exposed to the elevated temperatures of the operating turbine. Ideally, the butt gap 4, 6 is sized such that it allows expansion while maintaining a proper seal between stages. If the butt gap is too large, then a residual space will remain between ring segments 4,6 after they thermally expand. Arrows 16 generally show the direction of the flow of the working fluid through the turbine in relation to the ring segments 4, 6. Given this flow, if residual space remains between the segment 4 and the segment 6 after thermal expansion, then a leakage path is formed, as working fluid will flow therebetween.

On the other hand, if the butt gap 12 is too small, then when the ring segments 4, 6 expand, they will butt together and expand to a larger diameter. This will increase the radial clearance between the teeth 10 of the ring segment 4, 6 and the turbine rotor shaft. Again, a leakage path will be formed and the overall efficiency of the turbine reduced.

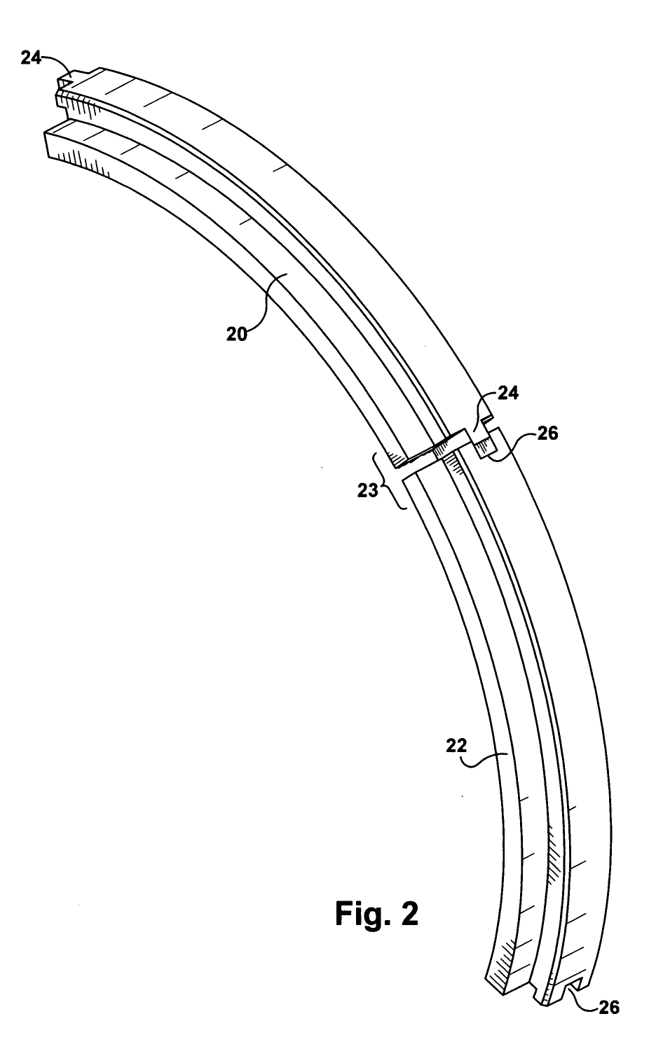

FIG. 2 illustrates ring segments 20, 22 according to an exemplary embodiment of the present invention. As shown, the interface between ring segment 20 and ring segment 22 may include a dovetail feature 23. As used herein, a dovetail feature is defined to include any interface that includes a male/female or insert/groove configuration. Thus, at each end, the ring segment 20 may include an insert 24. As used herein, insert may be defined to include as any protrusion that extends from an approximately flat surface. At each of its ends, the ring segment 22 may include a groove 26. As used herein, groove may be defined to include any depression or notch in an approximate flat surface. As shown, the insert 24 and the groove 26 may be similarly sized such that the insert 24 closely fits within the groove 26.

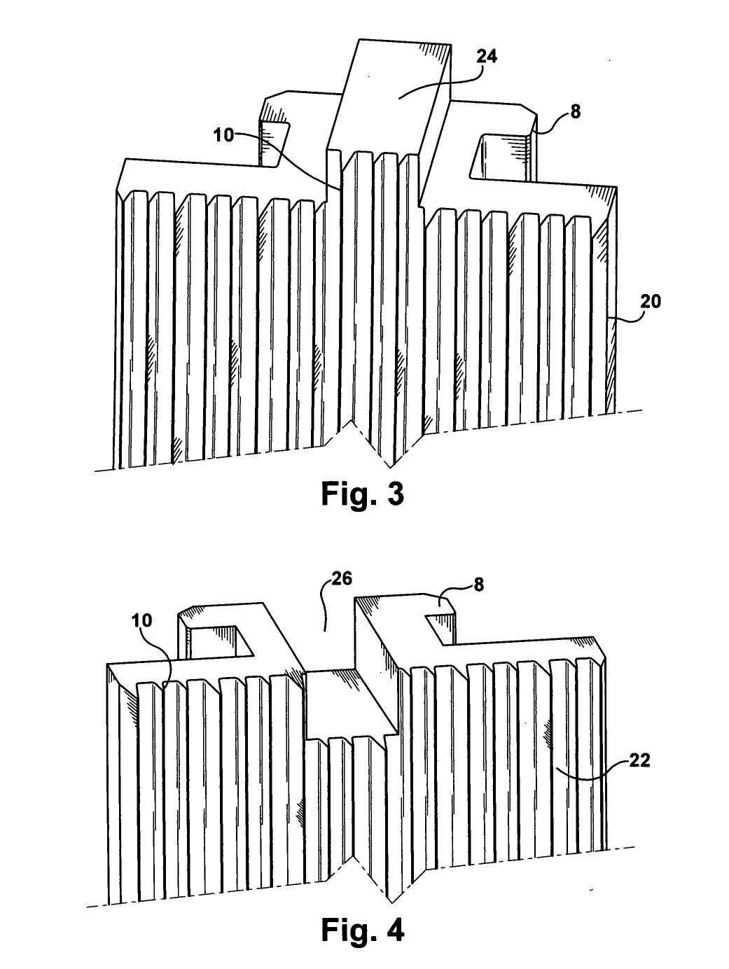

FIG. 3 illustrates a more detailed perspective view of the insert 24. As shown, the insert 24 may include a rectangular protrusion that is positioned at the end of ring segment 20. The length of the insert 24 may traverse the radial thickness of the ring segment 20. Thus, at the innermost radial end of the insert 24, the insert 24 may include the teeth 10. And, the outermost radial end of the insert 24 may extend through the engagement feature 8 of the ring segment 20. Those of ordinary skill in the art will recognize that other shapes for the insert 24 may be used.

FIG. 4 illustrates a more detailed perspective view of the groove 26. As shown, the groove 26 may be a rectangular depression or notch that is positioned in the end of ring segment 22. The length of the groove 26 may traverse the radial thickness of the ring segment 22. Thus, the groove 26 may traverse the end of the ring segment 22 from the teeth 10 through the engagement feature 8. Those of ordinary skill in the art will recognize that other shapes for the groove 26 may be used.

It will be understood by those of ordinary skill in the art that the insert 24 and the groove 26 are shaped and sized such that the insert 24 may fit closely within the groove 26. Thus, the width of the groove 26 may be slightly larger than the width of the insert 24.

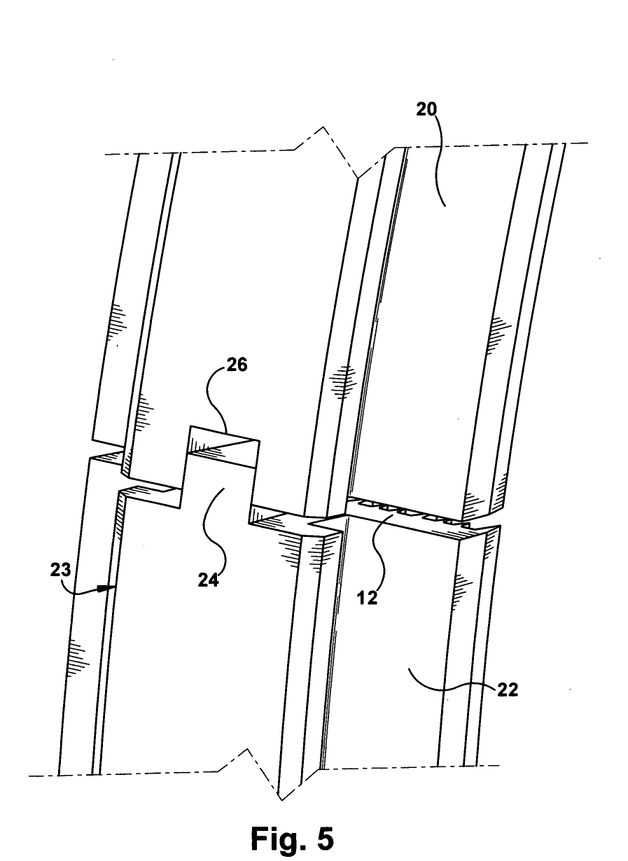

In use, as illustrated in FIG. 5, the insert 24/groove 26 configuration may allow the butt gap 12 to be sized such that an effective seal is maintained even if, at full thermal expansion a gap between the two ring segments 20, 22 remains. As shown in FIG. 5, space in the butt gap 12 remains. In conventional design, the gap would have allowed the axial flow of working fluid through it, which would have decreased the efficiency of the turbine. However, in embodiments of the present invention, axial flow through the butt gap 12 is prevented by the insert 24. Specifically, the insert 24 traverses the butt gap 12 and engages the groove 26, effectively blocking the axial flow of working fluid through the butt gap 12.

Thus, as illustrated in FIG. 5, the dovetail feature 23, i.e., the insert 24/groove 26 configuration, allows for a greater margin for error in the sizing of the butt gap 12. Specifically, a proper seal may be maintained even if the butt gap 12 between ring segments is sized so that a gap remains at full thermal expansion of the ring segments. In this manner, the risk of having a butt gap 12 that is too narrow (which would cause the end of the ring segments to butt together and expand to a larger diameter causing a leakage path) may be avoided.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A packing ring in a multi-staged turbine, comprising two ring segments joined by a dovetail feature.

2. The packing ring of claim 1, wherein the dovetail feature comprises a male/female configuration.

3. The packing ring of claim 1, wherein the dovetail feature comprises an insert/groove configuration.

4. The packing ring of claim 3, wherein the insert of the insert/groove configuration comprises a protrusion that extends from an approximately flat surface of an end of one of the ring segments.

5. The packing ring of claim 3, wherein the groove of the insert/groove configuration comprises a notch in an approximate flat surface of an end of one of the ring segments.

6. The packing ring of claim 3, wherein the insert of the insert/groove configuration and the groove of the insert/groove configuration comprise a similar size such that the insert closely fits within the groove.

7. The packing ring of claim 3, wherein the insert of the insert/groove configuration comprises a rectangular protrusion that is positioned at the end of ring segment.

8. The packing ring of claim 7, wherein the length of the insert traverses the radial thickness of the ring segment.

9. The packing ring of claim 7, wherein the groove of the insert/groove configuration comprises a rectangular depression that is positioned in the end of ring segment.

10. The packing ring of claim 9, wherein the length of the groove traverses the radial thickness of the ring segment.

11. A packing ring in a multi-staged turbine, comprising:
a ring segment that includes an insert at one end; and
a ring segment that includes a groove at one end.

12. The packing ring of claim 11, wherein the insert and the groove are sized so that the insert may engage the groove.

13. The packing ring of claim 11, wherein the outer radial face of each of the ring segments include an engagement feature so that the ring segments may be engaged by an inner radial face of a turbine casing; and
the inner radial face of each of the ring segments include teeth.

14. The packing ring of claim 11, wherein the insert comprises a protrusion that extends from an approximately flat surface of an end of one of the ring segments.

15. The packing ring of claim 11, wherein the groove comprises a notch in an approximate flat surface of an end of one of the ring segments.

16. The packing ring of claim 11, wherein the insert and the groove comprise a similar size such that the insert closely fits within the groove.

17. The packing ring of claim 11, wherein the insert of the insert/groove configuration comprises a rectangular protrusion that is positioned at the end of ring segment.

18. The packing ring of claim 17, wherein the length of the insert traverses the radial thickness of the ring segment.

19. The packing ring of claim 17, wherein the groove of the insert/groove configuration comprises a rectangular depression that is positioned in the end of ring segment.

20. The packing ring of claim 19, wherein the length of the groove traverses the radial thickness of the ring segment.
